(19) United States
(12) Patent Application Publication
(10) Pub. No.: US 2006/0168640 A1
(43) Pub. Date: Jul. 27, 2006

(54) Media device and enhancing use of media device

(76) Inventors: Akseli Anttila, Helsinki (FI); Oleg Beletski, Espoo (FI); Jukka Heinonen, Helsinki (FI); Tony Niklas Von Knorring, Helsinki (FI); Toni Kopra, Vantaa (FI); Arto Leppisaari, Kangasala (FI); Raimo Malila, Helsinki (FI); Mikko Makipaa, Helsinki (FI); Ingrid Schembri, Vantaa (FI); Hartti Suomela, Sunnyvale, CA (US)

Correspondence Address: Hollingsworth & Funk, LLC, Suite 125, 8009 34th Avenue South, Minneapolis, MN, 55425, US

(21) Appl. No.: 11/043,818

(22) Filed: Jan. 26, 2005

(51) Int. Cl. H04N 7/16

(52) U.S. Cl. 725/135; 725/62

(57) ABSTRACT

A media device and a method of enhancing the use of a media device are provided. The media device is configured to receive a broadcast media stream transmitted by a broadcast system by the media. A contact list comprising contact information of is maintained. The media device receives over a radio interface of a cellular telecommunication system a service transmission associated with the broadcast media stream, the service transmission comprising information about the content of the broadcast media stream. The contact list is updated on the basis of the received service.

### FIELD

The invention relates to a media device and enhancing the use of a media device. Especially the invention relates to media devices configured to receive a broadcast media stream from a broadcast system.

### BACKGROUND

Broadcasters, such as television and radio broadcasters, have taken steps forward to provide an audience with digital supplementary services, such as program information, news, weather information, competitions and other related content, in addition to a traditional media stream. The digital supplementary services are usually delivered to the audience over the Internet using the audiences' personal-computers or other media devices capable of connecting to the Internet.

More mobility is provided for the audience by media devices of cellular telecommunication systems, which media devices are equipped with a receiver, such as an FM radio, for receiving media streams broadcast by broadcasters. Broadcasters typically provide Internet services, which can be accessed by media devices, such as the one equipped with a WAP (Wireless Application Protocol), capable of connecting to such a service.

Broadcasters often encourage listeners to take part in competitions or polls advertised in the broadcast stream or the associated service. Users may participate typically via the associated service or by making a phone call or sending a text message to a number given by the broadcasters.

Immediate access to these numbers may be problematic. First, the number must be obtained somewhere. The number may be mentioned in the transmission or the number may be included in a visual form in the associated service transmission. In either case, the user must manually type the number before a phone call or text message can be performed.

### BRIEF DESCRIPTION OF THE INVENTION

An object of the invention is to enhance the use of a media device by providing an improved solution for updating the contact list maintained by the media device. According to an aspect of the invention, there is provided a method of enhancing the use of a media device, configured to receive a broadcast media stream transmitted by a broadcast system, the method comprising: storing a contact list comprising contact information on recipients, receiving over a radio interface of a cellular telecommunication system a service transmission associated with the broadcast media stream, the service transmission comprising information about the content of the broadcast media stream; updating the contact list on the basis of the received service.

According to another aspect of the invention, there is provided a media device comprising: a receiver configured to receive a broadcast media stream transmitted by a broadcast system; a transceiver configured to communicate with a cellular telecommunication system and to receive a service transmitted over a radio interface of the cellular telecommunication system, the service being associated with at least one broadcast media stream; a processor connected to the receiver and transceiver, configured to maintain a contact list comprising contact information on recipients; and to update contact list on the basis of the received service.

According to another aspect of the invention, there is provided a server connected to a cellular telecommunication system, configured to receive a query from a media device of the cellular telecommunication system, the query regarding contact information of an originator of a service transmitted over a radio interface of the cellular telecommunication system, the service being associated with at least one broadcast media stream transmitted by a broadcast system; determine the contact information, and send the contact information to the media device.

The invention provides several advantages. The invention provides the user of a media device with an easy access to communication with a broadcast station. Thus, the user may easily take part in competitions and polls, for example. The proposed solution enhances the listening experience.

In an embodiment, the media device is capable of performing half duplex speech transmission over a packet connection of a cellular telecommunication system. The contact list comprises contact information on recipients of half duplex speech transmissions.

### LISTING OF DRAWINGS

In the following, the invention will be described in greater detail with reference to the embodiments and the accompanying drawings, in which

FIG. 1A illustrates an example of a system in which embodiments of the invention may be utilized;

FIG. 1B illustrates a half duplex speech transmission over a packet connection;

FIG. 2 illustrates an example of a media device;

FIG. 3 illustrates an embodiment of the invention as a flow chart,

FIG. 4A, 4B and 4C illustrate embodiments of the invention in more detail.

### DESCRIPTION OF EMBODIMENTS

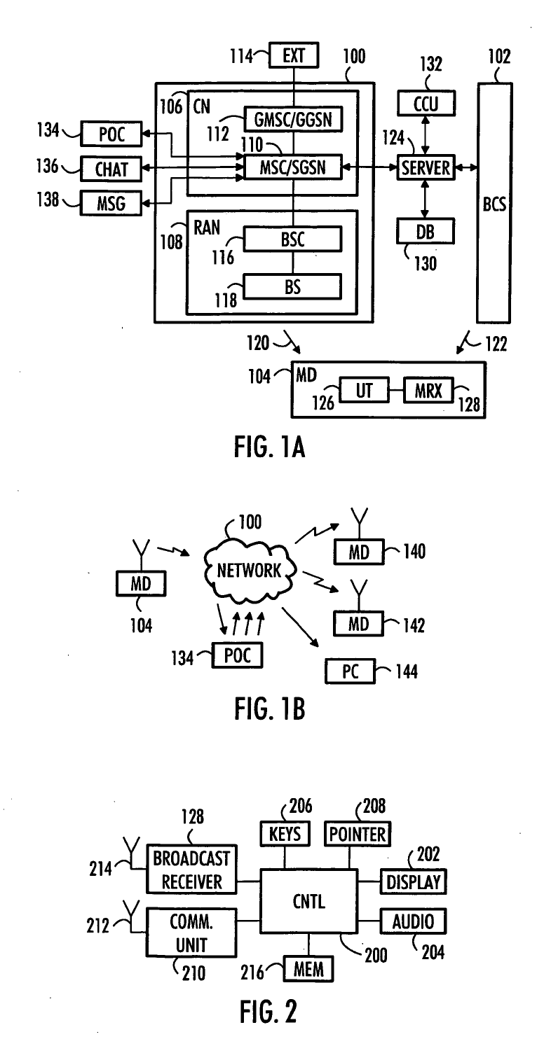

FIG. 1A illustrates an example of a simplified structure of a system in which embodiments of the invention may be utilized. The system comprises a communication network 100 of a cellular telecommunications system, a broadcast system 102, and a media device 104 of the cellular telecommunications system.

The cellular telecommunications system is based on, for example, the GSM (Global System for Mobile Communications) or UMTS (Universal Mobile Telecommunications System). The radio interface used in the communication between the communication network and the media device may be realized using WCDMA (Wideband Code Division Multiple Access) technology, GPRS (General Packet Radio Service) or WLAN (Wireless Local Area Network), or any other similar solution offering services. The structure and functions of cellular telecommunications systems are known to a person skilled in the art, and therefore all network elements of the system are not illustrated.

The communication network 100 provides the media device 104 with bidirectional communication services. The broadcast system 102 provides the media device 104 with a media stream 122 using, for example, a radio or television broadcast. The television broadcast may be realised as a DVB-H (Digital Video Broadcasting—Transmission system for handheld terminals) transmission.

The communication network 100 may represent the fixed infrastructure of the cellular telecommunication system. The communication network 100 may comprise a core network (CN) 106 representing a radio-independent layer of the communication network 100, and at least one radio access network (RAN) 108. The core network 106 may include network elements of different generations of cellular telecommunications systems. The radio access network 108 provides the media device 104 with a radio interface using radio access technology. The media device thus has a bi-directional radio connection 120 with the radio access network 108.

In the example shown in FIG. 1A, the core network 106 is exemplified in terms of GSM terminology using both circuit-switched and packet-switched network elements. The packet-switched network elements are described in terms of the GPRS (General Packet Radio Service) system, which provides the media device 104 with access to external data networks over GSM and supports standard protocols, such as TCP (Transmission Control Protocol) and IP (Internet Protocol). The invention is not, however, restricted to the systems, division of systems, or protocols used in the system described in the examples, but can be applied to any cellular telecommunications system.

A center 110 represents a mobile services switching center (MSC) and a serving GPRS support node (SGSN) enabling circuit-switched and packet-switched signaling, respectively, in the cellular telecommunications system.

A function of the serving GPRS support node is to transmit packets to and receive them from the media device 104 supporting packet-switched transmission. The serving GPRS support node includes subscriber information and location information about the media device 104.

The core network 106 may also have a gateway unit 112 representing both a gateway mobile service switching center (GMSC) and a gateway GPRS support node (GGSN). The GMSC attends to the circuit-switched connections between the core network 106 and external networks (EXT) 114 such as a public land mobile network (PLMN) or a public switched telephone network (PSTN), and the GGSN attends to the packet-switched connections between the core network 106 and external networks 114 such as the Internet.

The center 110 controls the radio access network 108, which may comprise at least one base station controller (BSC) 116 controlling at least one base station (BS) 118. The base station controller 116 may also be called a radio network controller, and the base station 118 may be called a node B.

The system of FIG. 1A further comprises a server 124 connected to the communication network 100 and the broadcast system 102 for providing the media device 104 with a service associated with the media stream 122 by using the radio interface of the cellular telecommunication system. The server 124 may be a computer, such as a personal computer or a workstation with an interface to the communication network 100 and the broadcast system 102. The physical location of the server 124 is not relevant as far as required connections exist. The server 124 may comprise a database 130. The database 130 may comprise computer files containing the service content.

The server 124 may be connected to the center 110, the gateway unit 112, the radio access network 106, or other parts of the communication network 100. The server 124 may be connected to the communication network 100 via an external network 114. In an embodiment, the server 124 communicates with the communication network 100 over the radio interface of the cellular telecommunication system.

The media device 104 comprises a user terminal 126 for communicating in the cellular telecommunication system using a radio interface provided by the base station 118. The media device 104 further comprises a media receiver 128, such as an FM receiver or a television receiver, for receiving a media stream 122 provided by the broadcast system 102.

The base station 118 may communicate with the media device 104 using GPRS, in which data is transferred in packets that contain address and control data in addition to the actual content data. Several connections may employ the same transmission channel simultaneously. This kind of packet switching method is suitable for data transmission where the data to be transmitted is generated in bursts. In such a case, it is not necessary to allocate a data link for the entire duration of transmission but only for the time it takes to transmit the packets. This reduces costs and saves capacity considerably during both the set-up and the use of the communication network 100.

The server 124, for example, controls the content flow between the media device 104 and the communication network 100. The server 124 may also facilitate timed delivery of content of the service to the media device 104.

The media stream 122 is broadcast by the broadcast system 102. The media stream 122 may include, for example, a radio or television program, a commercial or an announcement. The media stream 122 may include speech, music, or pictures. The content of the media stream 122, however, is not relevant to the present solution. The media device is configured to receive the broadcast media stream 122 with the media receiver 128.

The media device may be provided with a, service which is associated and/or synchronized with the broadcast media stream 122 transmitted by the broadcast system. In general, the service may provide the user of the media device with visual information relative to the content of the broadcast media stream 122. The service may be interactive. The service may include information about the music played at the moment, DJ's messages to the listeners or the like. The signal may include any of these features alone or a combination thereof. The service may include information about deliverable or purchasable objects related to the media stream, such as ring tones, desktop wallpapers or logos.

The service may be provided to the media device 104 utilizing a communication channel parallel to the broadcast channel used in delivering the media stream 122 to the user. This is called a parallel channel operation. A logical address may be dedicated to the service,120 so that the service 120 may be accessed by using the logical address of a database 130 of the server 124. The content of the service may vary as a function of time and possibly as a function of the content of the media stream 122. The service 120 provides a bit stream to the media device 104, the bit stream including information content, such as graphical information, text information, audio information, a computer program, Braille, vibration, or any combination thereof. In an embodiment, the content of the service 120 is displayed on a display of the media device 104.

A service provider is a party possessing rights for relevant digital content of the service 120, a distribution system for providing the media device 104 with the service 120, and possibly capability to bill the user for the service 120. The service provider's delivery system is responsible for receiving and handling delivery requests and delivering the service 120 to the media device 104.

In the media device 104, the service provides an integrated user experience, allowing the user to start both listening to a media stream 122 and receiving the content of the service relating to the media stream 122. The operation of the media is based on two channels, the broadcast channel and the parallel channel enabled by the cellular telecommunication system.

In an embodiment, the service concept may be called a visual radio. The broadcast system broadcasts a radio transmission 122 received by the media device 104. The DJ or announcer of the radio transmission may advertise the service realized with the parallel channel. The user of the media device may subscribe to the service by making contact with the server and downloading suitable data which enables the user's media device to receive the service. The data may be called associating data and it may comprise information which provides a linkage between the service and the media stream and which identifies the service transmission.

The associating data may include the following type of information: a radio service address, a service identification, an object identification, a radio broadcaster identification number, a program identification number, a traffic announcement identification number, a traffic program identification number, a program item number, an emergency warning message, a music/speech indicator, a radio frequency utilized by a media stream, a program service name, a program type identification number, and a country code.

In an embodiment, the associating data for service of each broadcast stream is stored in the same programmable program memory location as the information related to the broadcast media stream. Thus, when the user switches to another channel by selecting a programmable memory location the device is able to start receiving the associated service at the same time.

In an embodiment, the system comprises a content creation unit (CCU) 132 connected to the server 124 and the broadcast system 12 for providing content for the service. The content creation unit 132, which may also be called a visual radio tool in some applications, may be used to create service content presentation to be displayed on the media device 104. The content creation unit 132 may be located and integrated into the broadcast system 102, or into the server 124.

The content creation unit 132 may allow a broadcast system to create a visual presentation and manage the content flow shown on the screen of the media device 104 in synchronization with the media stream 122.

The content creation unit 132 may also define timing to display the content of the service in the media device 104 in relation to broadcast media stream timeline.

FIG. 1A shows a broadcast system 102 and a server 124. In practice, there may be several broadcast systems in the same area and each broadcast system may have a server of its own. The servers are connected to the communication network 100 in a similar manner as the server 124. In an embodiment, the server 124 may be connected to several broadcast systems. In another embodiment, the broadcast system 102 may transmit several broadcast media streams.

In an embodiment, the system of FIG. 1A further comprises a POC (Push to talk over cellular) server 134 connected to the communication network 100. Push to talk over cellular (POC) service provides the cellular network with a direct one-to-one and one-to-many voice communication service. The POC service is based on half duplex Voice over IP (VoIP) technology over a packet-switched connection, such as GPRS or Enhanced GPRS (EGPRS).

The POC offers the users a direct one-to-one or one-to-many communication service. In an embodiment, a media device comprises a POC contact list which comprises contact information of recipients with which a POC connection can be established. Typically, the user of the media device updates the contact list manually. In an embodiment, the contact list resides in the local memory of the media device. In another embodiment, the contact list may reside in a synchronized manner in both the local memory and in a network directory service. In an embodiment, the contact list resides only in the network. A given contact may be configured to be a default contact. The media device comprises a Push to talk (PTT) button. When the PTT button is pressed, a unidirectional voice channel is established to the default recipient. The user of the media device may also select a recipient from the contact list and press the PTT button. In such a case a unidirectional connection is established to the selected recipient. The recipient may be a group of users, in which case a unidirectional group call is established. As the connection is established using a packet-switched connection, the connection set up is very fast. When a recipient's media device receives a POC connection set up request, it may alert the user with a tone. The connection may be established directly or after the user of the media device has accepted the connection, depending on the parameters set up by the recipient.

POC connections are unidirectional: while a user speaks, the recipient or recipients listen and are unable to send. The opportunity to speak is requested by pressing the PTT button. The turns to speak are granted by the system on a first come first served basis. FIG. 1B illustrates a POC group call. The media device 104 of a speaking user sends packet data traffic to the POC server 134 via network 100. In case of a group call, the server 134 then duplicates the traffic to all the recipients 140, 142, 144 of the call. Group creation and attachment control are based on a Session Initiation Protocol (SIP), for example.

In an embodiment, the system of FIG. 1A further comprises a chat server 136 connected to the communication network 100. The chat server maintains a chat service. A chat service provides the users of the cellular network with a direct one-to-one and one-to-many communication service based on text or multimedia messages. In chat service, participants may set up a chat room, which is a virtual place to exchange messages. Chat rooms may be public, i.e open to all or they may be private, i.e. the participation is restricted to given users. A participant in a chat may send a message to one or many recipients. The recipients receive the message simultaneously and each participant may respond to the message. All messages are visible to all participants of the given chat room.

In an embodiment, the system of FIG. 1A further comprises a messenger server 138 connected to the communication network 100. The messenger server maintains a messenger service. A messenger service provides the users of the cellular network with a direct one-to-one and one-to-many communication service based on text or multimedia messages. A messenger service is in many ways similar to a chat service, except that conversations are usually private.

FIG. 2 discloses an example of a media device in which embodiments of the invention can be applied. The media device comprises a controller 200, typically implemented with a microprocessor, a signal processor or separate components and associated software. The device further comprises a display 202. The display is typically configured to display graphics and text. The device may also comprise an audio interface 204, which may be realized with a speaker or a headset and a microphone, for example. The device may further comprise a keypad 206 and a pointer device 208, such as a mouse, a track stick, a touch-pad or a stylus. Depending on the type of the device, there may be different number of user interface parts.

The media device also comprises a communication unit 210 implementing the functions of terminal equipment including speech and channel coders, modulators and RF parts. The device may also comprise an antenna 212 connected to the communication unit. The communication unit is configured to act not only as a transceiver in conventional phone calls but also as a transmitter performing half duplex speech transmission over a packet connection of a cellular telecommunication system. The communication unit is further configured to receive over a radio interface of a cellular telecommunication system a service transmission associated with broadcast media streams.

The device also comprises a broadcast receiver 128 configured to receive broadcast transmissions sent by a broadcast system. The receiver 128 may be a radio or television receiver, for example. The received broadcast media stream may be an FM radio transmission or a DVB-H digital video transmission, for example. The device may also comprise an antenna 214 connected to the broadcast receiver 128. The device may also comprise a single antenna connected to both the communication unit 210 and the broadcast receiver 128. The device also typically comprises a memory 216 for storing e.g. telephone numbers, contact lists, communication parameters, broadcast receiver parameters, calendar data and other user-specific data. The memory may be realized with memory circuits or units or with detachable memory cards.

The media device is not restricted to the above example. The media device may be a personal computer, a personal digital assistant, terminal equipment or any other device comprising required communication facilities.

In an embodiment, the keypad 206 of the media device comprises a PTT key used to initiate a POC speech turn. A POC contact list comprising contact information of recipients with which a POC connection can be established is stored in the memory 216 of the media device.

In an embodiment of the invention, the POC contact list is updated on the basis of the associated service.

In an embodiment, the contact list maintained by the media device may comprise contact information of recipients with which a chat or a messenger service connection can be established. The contact list is updated on the basis of the associated service.

The contact information in the contact list may be in different formats. For example, a SIP address, which may be used for Chat and POC services, is of format

sip:john.doe@operator.com.

The contact information may be a telephone number:

tel:+35850123456.

The contact information may also be based on Wireless Village protocol, which may be used for chat and messenger services, for example. For point-to-point contacts, the contact information may be of format:

wv:john.doe@operator.com,

wv:+358905123456@operator.com,

wv:+35805123456.

For chat services, the contact information may be of format:

wv: wv:/technicalforum@operator.com,

wv: wv:john/technicalforum@operator.com,

wv:+35805123456.

For POC services, the contact information may be of format:

POC: sip:technicalforum@operator.com.

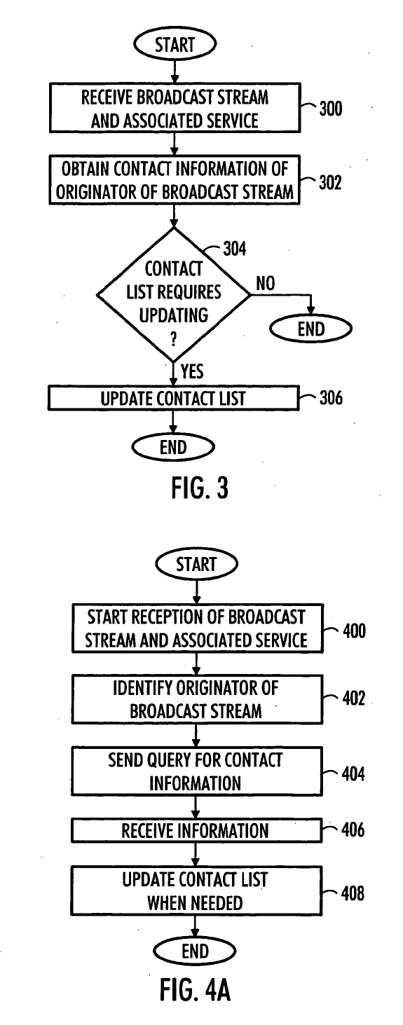

FIG. 3 illustrates an embodiment of the invention with a flowchart. The embodiment describes the use of POC in media device, but respective steps apply also in the case of a chat or a messenger service.

In step 300, a media device receives a broadcast media stream transmitted by a broadcast system and a service transmission associated with the broadcast media stream over a radio interface of a cellular telecommunication system, the service transmission comprising information about the content of the broadcast media stream.

In step 302, the media device identifies the originator of the broadcast media stream and obtains contact information on the originator. The contact information enables the user of the media device to contact the originator by phone, for example.

In step 304, it is checked whether the POC contact list already contains the contact information on the originator of the broadcast media stream. If this is the case, the process ends.

In step 306, the POC contact list is updated with the contact information on the originator of the broadcast media stream.

Steps 304 and 306 may include conducting searches in both the local memory of the device and the associate server side POC contact list, depending on whether the implementation of the POC contact list is based on the terminal only, synchronized terminal and server list, or a server only contact list.

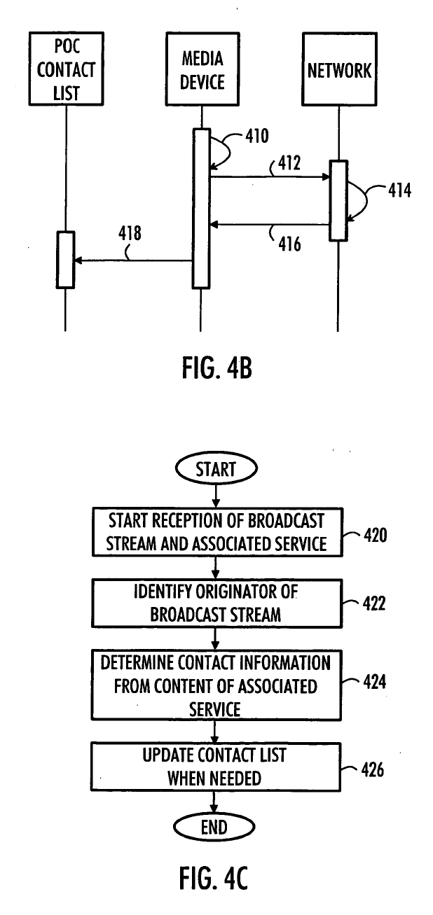

FIGS. 4A and 4B illustrate an embodiment of the invention in more detail.

In step 400, a media device starts 410 reception of a broadcast media stream transmitted by a broadcast system and a service transmission associated with the broadcast media stream over a radio interface of a cellular telecommunication system, the service transmission comprising information about the content of the broadcast media stream.

In step 402, the media device identifies the originator of the broadcast media stream. The identification is obtained from the associated service transmission.

In step 404, the media device sends a query 412 for the contact information of the originator to the cellular telecommunication network. The recipient of the query may be a server connected to a cellular telecommunication system and maintaining a list of stations sending associated service transmissions. The recipient may also be the server sending the associated service. The server determines 414 the contact information and sends a response 416 to the media device, which receives the requested information in step 406.

In step 408, the media device updates 418 the POC contact list with the contact information on the originator of the broadcast media stream, if the respective information is not already on the list.

FIG. 4C illustrates another embodiment of the invention in more detail.

In step 420, a media device starts the reception of a broadcast media stream transmitted by a broadcast system and a service transmission associated with the broadcast media stream over a radio interface of a cellular telecommunication system, the service transmission comprising information about the content of the broadcast media stream.

In step 422, the media device identifies the originator of the broadcast media stream. The identification is obtained from the associated service transmission.

In step 424, the media device determines the contact information of the originator from the content of the associated service. The contact information may be included in the associated service in such a form that the media device is able to detect the information automatically.

In step 426, the media device updates 418 the POC contact list with the contact information of the originator of the broadcast media stream, if the respective information is not already on the list.

In an embodiment, the proposed solution is implemented as a computer program distribution medium readable by a computer and encoding a computer program of instructions for executing a computer process for enhancing the use of a media device, configured to receive a broadcast media stream transmitted by a broadcast system by the media. The process comprises storing a contact list comprising contact information of, receiving over a radio interface of a cellular telecommunication system a service transmission associated with the broadcast media stream, the service transmission comprising information about the content of the broadcast media stream and updating the contact list on the basis of the received service.

The distribution medium may be at least one of the following: a computer readable medium, a program storage medium, a record medium, a computer readable memory, a computer readable software distribution package, a computer readable signal, a computer readable telecommunications signal, or a computer readable compressed software package.

Even though the invention is described above with reference to an example according to the accompanying drawings, it is clear that the invention is not restricted thereto but it can be modified in several ways within the scope of the appended claims.

1. A method of enhancing the use of a media device, configured to receive a broadcast media stream transmitted by a broadcast system, the method comprising:
storing a contact list comprising contact information on recipients, receiving over a radio interface of a cellular telecommunication system a service transmission associated with the broadcast media stream, the service transmission comprising information about the content of the broadcast media stream;
updating the contact list on the basis of the received service.

2. The method of claim 1, wherein the media device is configured to perform half duplex speech transmission over a packet connection of a cellular telecommunication system, and the contact list comprises contact information on recipients of half duplex speech transmissions.

3. The method of claim 1, wherein the service transmission comprises contact information on the originator of the broadcast media stream.

4. The method of claim 1, wherein the contact information is a SIP address.

5. The method of claim 4, wherein the contact information is valid for a predetermined time period.

6. The method of claim 1, wherein the contact information is an address based on Wireless Village protocol.

7. The method of claim 1, wherein the contact information is an address of a messaging service.

8. The method of claim 1, wherein the contact information is an address of a chat service.

9. The method of claim 1, further comprising:
initiating reception of a service over radio interface of a cellular telecommunication system;
identifying the originator of the broadcast media stream the service is associated with;
determining contact information of the originator;
updating the contact list with the contact information of the originator.

10. The method of claim 1, further comprising:
sending a query for the contact information of the originator to the cellular telecommunication network;
receiving the contact information as a response to the query.

11. The method of claim 1, further comprising:
determining contact information of the originator from the content of the associated service.

12. The method of claim 1, further comprising:
loading contact information of the originator from a memory of the media device.

13. The method of claim 1, wherein the broadcast media stream is an FM radio transmission.

14. The method of claim 1, wherein the broadcast media stream is a DVB-H digital video transmission.

15. The method of claim 1, further comprising:
storing the contact list to a memory of the media device.

16. The method of claim 1, further comprising:
storing the contact list to a server of the cellular telecommunication system.

17. A media device comprising:
a receiver configured to receive a broadcast media stream transmitted by a broadcast system;
a transceiver configured to communicate with a cellular telecommunication system and to receive a service transmitted over a radio interface of the cellular telecommunication system, the service being associated with at least one broadcast media stream;
a processor connected to the receiver and transceiver, configured to maintain a contact list comprising contact information on recipients; and to update contact list on the basis of the received service.

18. A media device of claim 17, wherein the transceiver is further configured to perform half duplex speech transmission over a packet connection of a cellular telecommunication system, and the processor is configured to maintain a contact list comprising contact information on recipients of half duplex speech transmissions.

19. A media device of claim 17, further comprising a memory, connected to the processor, for storing the contact list.

20. A media device of claim 17, wherein the processor is further configured to:
initiate reception of a service over radio interface of a cellular telecommunication system;
identify the originator of the broadcast media stream the service is associated with;
determine contact information of the originator;
update the contact list with the contact information of the originator.

21. A media device of claim 17, wherein the processor is further configured to:
send a query for the contact information of the originator to the cellular telecommunication network;
receive the contact information as a response to the query.

22. A media device of claim 17 wherein the processor is further configured to determine contact information of the originator from the content of the associated service.

23. A media device of claim 17, wherein the media device is further configured to receive an FM radio transmission as a broadcast media stream.

24. A media device of claim 17, wherein the media device is further configured to receive a DVB-H digital video transmission as a broadcast media stream.

25. A media device comprising:
means for receiving a broadcast media stream transmitted by a broadcast system;
means for communicating with a cellular telecommunication system;
means for receiving a service transmitted over a radio interface of the cellular telecommunication system, the service being associated with at least one broadcast media stream,
means for storing a contact list comprising contact information on recipients; and
means for updating the contact list on the basis of the received service.

26. A media device of claim 25, wherein the media device further comprises
means for storing a contact list comprising contact information on recipients of half duplex speech transmissions and
means for performing half duplex speech transmission over a packet connection of a cellular telecommunication system.

27. A server connected to a cellular telecommunication system, configured to
receive a query from a media device of the cellular telecommunication system, the query regarding contact information of an originator of a service transmitted over a radio interface of the cellular telecommunication system, the service being associated with at least one broadcast media stream transmitted by a broadcast system;
determine the contact information, and
send the contact information to the media device.

28. A server of claim 27, wherein the server is configured to transmit the associated service.

29. A server of claim 27, wherein the server is configured to maintain contact information of at least one originator of an associated service.

30. A computer program product encoding a computer program of instructions for executing a computer process for enhancing the use of a media device, configured to receive a broadcast media stream transmitted by a broadcast system with the media device, the process comprising:
storing a contact list comprising contact information on,
receiving over a radio interface of a cellular telecommunication system a service transmission associated with the broadcast media stream, the service transmission comprising information about the content of the broadcast media stream;
updating the contact list on the basis of the received service.

31. A computer program distribution medium readable by a computer and encoding a computer program of instructions for executing a computer process for enhancing the use of a media device, configured to receive a broadcast media stream transmitted by a broadcast system with the media device, the process comprising:
storing a contact list comprising contact information on, receiving over a radio interface of a cellular telecommunication system a service transmission associated with the broadcast media stream, the service transmission comprising information about the content of the broadcast media stream;
updating the contact list on the basis of the received service.

32. The computer program distribution medium of claim 31, the distribution medium comprising at least on of following: a computer readable medium, a program storage medium, a record medium, a computer readable memory, a computer readable software distribution package, a computer readable signal, a computer readable telecommunications signal, or a computer readable compressed software package.
